(19) United States
(12) Patent Application Publication
(10) Pub. No.: US 2014/0249256 A1
(43) Pub. Date: Sep. 4, 2014

(54) Texture Material for Covering a Repaired Portion of a Textured Surface

(71) Applicant: Homax Products, Inc., Bellingham, WA (US)

(72) Inventor: John Kordosh, Simi Valley, CA (US)

(21) Appl. No.: 13/798,064

(22) Filed: Mar. 12, 2013

Related U.S. Application Data
(63) Continuation-in-part of application No. 13/560,733, filed on Jul. 27, 2012.
(60) Provisional application No. 61/664,678, filed on Jun. 26, 2012.

(51) Int. Cl. C09D 5/00

(52) U.S. Cl. CPC C09D 5/00
USPC 524/108; 524/365; 524/379

(57) ABSTRACT

A texture material composition contains, by weight of the texture material, between 11.0% and 72.0% of solvent, between 3.0% and 8.0% of binder, between 0.5% and 3.0% of pigment, between 0.01% and 0.20% of an anti-settling agent, between 0.20% and 3.0% of a dispersant, and between 50.0% and 80.0% of filler.

### RELATED APPLICATIONS

This application (Attorney's Ref. No. P217318) claims benefit of U.S. Provisional Patent Application Ser. No. 61/664,678 filed Jun. 26, 2012.

This application (Attorney's Ref. No. P217318) is a continuation-in-part of U.S. patent application Ser. No. 13/560,733 filed Jul. 27, 2012.

The contents of all related applications listed above are incorporated herein by reference.

### TECHNICAL FIELD

The present invention relates to texture materials and, more specifically, to low odor texture materials.

### BACKGROUND

The present invention generally relates to systems and methods for applying texture material to an interior surface such as a wall or ceiling. In particular, buildings are typically constructed with a wood or metal framework. To form interior wall and ceiling surfaces, drywall material is attached to the framework. Typically, at least one primer layer and at least one paint layer is applied to the surface of the drywall material to form a finished wall surface.

For aesthetic and other reasons, a bumpy or irregular texture layer is often formed on the drywall material after the drywall material has been primed and before it has been painted. The appearance of the texture layer can take a number of patterns. As its name suggests, an “orange peel” texture pattern generally has the appearance of the surface of an orange and is formed by a spray of relatively small droplets of texture material applied in a dense, overlapping pattern. A “splatter” texture pattern is formed by larger, more spaced out droplets of texture material. A “knockdown” texture patter is formed by spraying texture material in larger droplets (like a “splatter” texture pattern) and then lightly working the surfaces of the applied droplets with a knife or scraper so that the highest points of the applied droplets are flattened. In some situations, a visible aggregate material such as polystyrene chips is added to the texture material to form what is commonly referred to as an “acoustic” or “popcorn” texture pattern. The principles of the present invention are of primary significance when applied to a texture material without visible aggregate material.

For larger applications, such as a whole room or structure, the texture layer is typically initially formed using a commercial texture sprayer. Commercial texture sprayers typically comprise a spray gun, a hopper or other source of texture material, and a source of pressurized air. The texture material is mixed with a stream of pressurized air within the texture gun, and the stream of pressurized air carries the texture material in droplets onto the target surface to be textured. Commercial texture sprayers contain numerous points of adjustment (e.g., amount of texture material, pressure of pressurized air, size of outlet opening, etc.) and thus allow precise control of the texture pattern and facilitate the quick application of texture material to large surface areas. However, commercial texture sprayers are expensive and can be difficult to set up, operate, and clean up, especially for small jobs where overspray may be a problem.

For smaller jobs and repairs, especially those performed by non-professionals, a number of “do-it-yourself” (DIY) products for applying texture material are currently available in the market. Perhaps the most common type of DIY texturing products includes aerosol systems that contain texture material and a propellant. Aerosol systems typically include a container, a valve, and an actuator. The container contains the texture material and propellant under pressure. The valve is mounted to the container selectively to allow the pressurized propellant to force the texture material out of the container. The actuator defines an outlet opening, and, when the actuator is depressed to place the valve in an open configuration, the pressurized propellant forces the texture material out of the outlet opening in a spray. The spray typically approximates only one texture pattern, so it was difficult to match a variety of perhaps unknown preexisting texture patterns with original aerosol texturing products.

A relatively crude work around for using an aerosol texturing system to apply more than one texture pattern is to reduce the pressure of the propellant material within the container prior to operating the valve. In particular, when maintained under pressure within the container, typical propellant materials exist in both a gas phase and in a liquid phase. The propellant material in the liquid phase is mixed with the texture material, and the texture material in the gas state pressurizes the mixture of texture material and liquid propellant material. When the container is held upright, the liquid contents of the container are at the bottom of the container chamber, while the gas contents of the container collect at the top of the container chamber. A dip tube extends from the valve to the bottom of the container chamber to allow the propellant in the gas phase to force the texture material up from the bottom of the container chamber and out of the outlet opening when the valve is opened. To increase the size of the droplets sprayed out of the aerosol system, the container can be inverted, the valve opened, and the gas phase propellant material allowed to flow out of the aerosol system, reducing pressure within the container chamber. The container is then returned upright and the valve operated again before the pressure of the propellant recovers such that the liquid contents are forced out in a coarser texture pattern. This technique of adjusting the applied texture pattern result in only a limited number of texture patterns that are not highly repeatable and can drain the can of propellant before the texture material is fully dispensed.

A more refined method of varying the applied texture pattern created by aerosol texturing patterns involved adjusting the size of the outlet opening formed by the actuator structure. Initially, it was discovered that the applied texture pattern could be varied by attaching one of a plurality of straws or tubes to the actuator member, where each tube defined an internal bore of a different diameter. The straws or tubes were sized and dimensioned to obtain fine, medium, and coarse texture patterns appropriate for matching a relatively wide range of pre-existing texture patterns. Additional structures such as caps and plates defining a plurality of openings each having a different cross-sectional area could be rotatably attached relative to the actuator member to change the size of the outlet opening. More recently, a class of products has been developed using a resilient member that is deformed to alter the size of the outlet opening and thus the applied texture pattern.

Existing aerosol texturing products are acceptable for many situations, especially by DIY users who do not expect perfect or professional results. Professional users and more demanding DIY users, however, will sometimes forego aerosol texturing products in favor of commercial texture sprayers because of the control provided by commercial texture sprayers.

The need thus exists for improved aerosol texturing systems and methods that can more closely approximate the results obtained by commercial texture sprayers.

### SUMMARY

The present invention may be embodied as a texture material composition that contains, by weight of the texture material, between 11.0% and 72.0% of solvent, between 3.0% and 8.0% of binder, between 0.5% and 3.0% of pigment, between 0.01% and 0.20% of an anti-settling agent, between 0.20% and 3.0% of a dispersant, and between 50.0% and 80.0% of filler.

The present invention may also be embodied as a texture material composition comprising, by weight of the texture material, between 1.0% and 20.0% of a medium evaporating solvent, between 0.0% and 10.0% of a slow evaporating solvent; between 8.0% and 57.0% of a fast evaporating solvent, between 3.0% and 10.0% of binder, between 0.5% and 3.0% of pigment, between 0.01% and 0.25% of an anti-settling agent, between 0.20% and 3.0% of a dispersant, and between 50.0% and 80.0% of filler.

### BRIEF DESCRIPTION OF THE DRAWINGS

FIG. 1 schematically represents a first example general class of aerosol texturing system of the present invention; and

FIG. 2 schematically represents a second example general class of aerosol texturing system of the present invention.

### DETAILED DESCRIPTION

The present invention may be embodied as a texture material composition adapted to be combined with an aerosol and dispensed using an aerosol dispensing system.

In the following discussion, example generic texture material compositions formulated in accordance with the principles of the present invention will first be described. After the description of the example generic texture material composition, two specific example texture material compositions formulated in accordance with the principles of the present invention will be described.

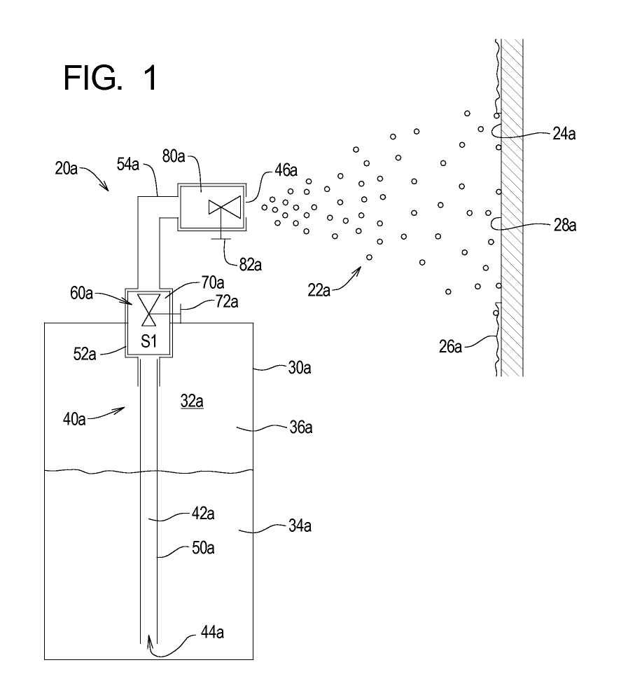

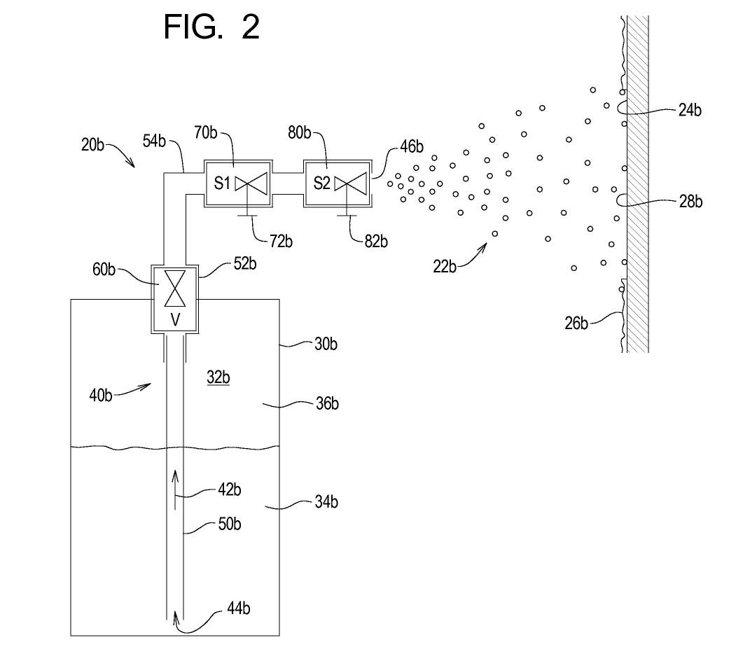

Next, several example aerosol assemblies for dispensing the example texture material compositions will be described with reference to FIGS. 1 and 2.

Finally, examples of stored material obtained by combining, in an aerosol dispensing assembly, texture material concentrate obtained using the example formulations described herein with propellant material will be described.

### I. Generic Texture Material Formulation Examples

In this section, example generic formulations of texture material compositions of the present invention will be provided. Each of these formulations yields a texture material concentrate that is combined with a propellant and possibly other materials in an aerosol assembly as will be described in further detail below.

### A. First Example Generic Formulation

The following Table IA-1 contains a first example generic formulation of a texture material composition of the present invention. In the following Table IA-1, components of the first example generic formulation are listed in the first column, and first and second ranges of these components are listed by percentage weight of the total weight of the composition in the second and third columns.

TABLE IA-1

| Component | First Range | Second Range |
|---|---|---|
| medium evaporating | 3.0-8.0 | 1.0-20.0 |
| solvent | | |
| slow evaporating solvent | 2.0-3.0 | 0-10.0 |
| fast evaporating solvent | 12.5-28.0 | 8.0-57.0 |
| binder | 4.0-6.0 | 3.0-10.0 |
| pigment | 1.0-2.0 | 0.5-3.0 |
| anti-settling agent | 0.05-0.10 | 0.01-0.25 |
| dispersant | 0.25-2.25 | 0.20-3.0 |
| filler/extender | 60.0-70.0 | 50.0-80.0 |

In the forgoing Table IA-1, the medium evaporating solvent evaporates at a slower rate than the fast evaporating solvent and at a higher rate than the slow evaporating solvent.

The following Table IA-2 lists, for each of the components of Table IA-1, an example material or example materials that may be used to perform those functions.

TABLE IA-2

| Component | Material(s) |
|---|---|
| medium evaporating | Diacetone alcohol; |
| solvent | |
| slow evaporating solvent | Propylene Carbonate; |
| fast evaporating solvent | Denatured Ethanol; |
| binder | Acrylic resin/binder; |
| pigment | Clay Pigment; |
| anti-settling agent | fumed silica; |
| dispersant | Solution of a partial amide and |
| | alkylammonium salt of a lower |
| | molecular weight unsaturated |
| | polycarboxylic acid polymer and a |
| | polisiloxane copolymer Lactimon |
| | (example registered tradename) |
| | BYK-Chemie Corp. |
| filler/extender | Calcium carbonate; |
| | Nepheline syenite |

### B. Second Example Generic Formulation

The following Table IB-1 contains a first example generic formulation of a texture material composition of the present invention. In the following Table IB-1, components of the first example generic formulation are listed in the first column, and first and second ranges of these components are listed by percentage weight of the total weight of the composition in the second and third columns.

TABLE IB-1

| Component | First Range | Second Range |
|---|---|---|
| solvent | 17.5-39.0 | 11.0-72.0 |
| binder | 4.0-6.0 | 3.0-8.0 |
| pigment | 1.0-2.0 | 0.5-3.0 |
| anti-settling agent | 0.05-0.10 | 0.01-0.20 |
| dispersant | 0.25-2.25 | 0.20-3.0 |
| filler/extender | 60.0-70.0 | 50.0-80..0 |

The following Table IB-2 lists, for each of the components of Table IB-1, an example material or example materials that may be used to perform those functions.

TABLE IB-2

| Component | Material(s) |
|---|---|
| solvent | Diacetone alcohol; |
| | Propylene Carbonate; |
| | Denatured Ethanol; |
| resin/binder | Acrylic resin/binder; |
| pigment | Clay Pigment; |
| anti-settling agent | fumed silica; |
| dispersant | Solution of a partial amide and |
| | alkylammonium salt of a lower |
| | molecular weight unsaturated |
| | polycarboxylic acid polymer and a |
| | polisiloxane copolymer Lactimon |
| | (example registered tradename) |
| | BYK-Chemie Corp. |
| filler/extender | Calcium carbonate; |
| | Nepheline syenite |

### II. Specific Example Texture Material Compositions

### A. First Specific Example

The attached Exhibit A contains Tables A-1 and A-2 containing examples of a texture material composition adapted to be combined with an aerosol and dispensed using an aerosol dispensing system in accordance with the principles of the present invention. Each value or range of values in Tables A-1 and A-2 represents the percentage of the overall weight of the example texture material composition formed by each material of the texture material composition for a specific example, a first example range, and a second example range.

One example of a method of combining the materials set forth in Tables A-1 and A-2 is as follows. Materials A, B, C, and D are combined to form a first sub-composition. The first sub-composition is mixed until material D is dissolved (e.g., 30-40 minutes). Materials E and F are then added to the first sub-composition to form a second sub-composition. The second sub-composition is mixed until materials E and F are well-dispersed (e.g., at high speed for 15-20 minutes). Material G is then added to the second sub-composition to form a third sub-composition. The third sub-composition is mixed well (e.g., 10 minutes). Typically, the speed at which the third sub-composition is mixed is reduced relative to the speed at which the second sub-composition is mixed. Next, materials H, I, and J are added to the third sub-composition to form the example texture material composition of the present invention. The example texture material composition is agitated. Material K may be added as necessary to adjust (e.g., reduce) the viscosity of the example texture material composition.

### B. Second Specific Example

The attached Exhibit B contains a Table B containing examples of a texture material composition adapted to be combined with an aerosol and dispensed using an aerosol dispensing system in accordance with the principles of the present invention. Each value or range of values in Table B represents the percentage of the overall weight of the example texture material composition formed by each material of the texture material composition for a specific example, a first example range, and a second example range.

One example of a method of combining the materials set forth in Table B is as follows. Materials A, B, C, and D are combined to form a first sub-composition. The first sub-composition is mixed until material D is dissolved (e.g., 30-40 minutes). Materials E and F are then added to the first sub-composition to form a second sub-composition. The second sub-composition is mixed until materials E and F are well-dispersed (e.g., at high speed for 15-20 minutes). Material G is then added to the second sub-composition to form a third sub-composition. The third sub-composition is mixed well (e.g., 10 minutes). Typically, the speed at which the third sub-composition is mixed is reduced relative to the speed at which the second sub-composition is mixed. Next, materials H, I, and J are added to the third sub-composition to form the example texture material composition of the present invention. The example texture material composition is agitated. Material K may be added as necessary to adjust (e.g., reduce) the viscosity of the example texture material composition.

The example texture material composition of the present invention may be combined with an aerosol propellant in an aerosol dispensing system to facilitate application of the example texture material composition to a surface to be textured. Alternatively, the example texture material composition may be entrained in a stream of pressurized fluid such as air and deposited on a surface to be textured. Example methods for applying the example texture material thus include an aerosol dispensing system, hand-operated spray pump, hopper spray gun, or the like.

### III. Example Aerosol Dispensing Systems

In this section, several example aerosol assemblies for dispensing texture material compositions of the present invention will be described. In addition to the example aerosol assemblies described herein, the texture material compositions of the present invention may be dispensed using aerosol assemblies such as those depicted and described in U.S. Pat. Nos. 7,278,590 and 7,500,621 and U.S. Patent Application Publication Nos. US/2013/0026252 and US/2013/0026253.

### A. First Example Aerosol Assembly

Referring now to FIG. 1 of the drawing, depicted at 20a therein is a first example aerosol dispensing system constructed in accordance with, and embodying, the principles of the present invention. The first example dispensing system is adapted to spray droplets of dispensed material 22a onto a target surface 24a. The example target surface 24a has a textured portion 26a and an un-textured portion 28a. Accordingly, in the example use of the dispensing system 20a depicted in FIG. 1, the dispensed material 22a is or contains texture material, and the dispensing system 20a is being used to form a coating on the un-textured portion 28a having a desired texture pattern that substantially matches a pre-existing texture pattern of the textured portion 26a.

FIG. 1 further illustrates that the example dispensing system 20a comprises a container 30a defining a chamber 32a in which stored material 34a and pressurized material 36a are contained. The stored material 34a is a mixture of texture material and propellant material in liquid phase, while the pressurized material is propellant material in gas phase.

FIG. 1 further illustrates that the first example aerosol dispensing system 20a comprises a conduit 40a defining a conduit passageway 42a. The conduit 40a is supported by the container 30a such that the conduit passageway 42a defines a conduit inlet 44a arranged within the chamber 32a and a conduit outlet 46a arranged outside of the chamber 32a. The conduit outlet 46a may alternatively be referred to herein as an outlet opening 46a. The example conduit 40a is formed by an inlet tube 50a, a valve housing 52a, and an actuator structure 54a. The conduit passageway 42a extends through the inlet tube 50a, the valve housing 52a, and the actuator structure 54a such that the valve housing 52a is arranged between the conduit inlet 44a and the actuator structure 54a and the actuator structure 54a is arranged between the valve housing 52a and the conduit outlet 46a.

Arranged within the valve housing 52a is a valve system 60a. A first flow adjustment system 70a having a first adjustment member 72a is arranged to interface with the valve system 60a. A second flow adjustment system 80a having a second adjustment member 82a is arranged in the conduit passageway 42a to form at least a portion of the conduit outlet 46a.

The valve system 60a operates in a closed configuration, a fully open configuration, and at least one of a continuum or plurality of partially open intermediate configurations. In the closed configuration, the valve system 60a substantially prevents flow of fluid along the conduit passageway 42a. In the open configuration and the at least one intermediate configuration, the valve system 60a allows flow of fluid along the conduit passageway 42a. The valve system 60a is normally in the closed configuration. The valve system 60a engages the actuator member structure 54a and is placed into the open configuration by applying deliberate manual force on the actuator structure 54a towards the container 30a.

The first flow adjustment system 70a is supported by the container 30a to engage the actuator structure such that manual operation of the first adjustment member 72a affects operation of the valve system 60a to control the flow of fluid material along the conduit passageway 42a. In particular, the first adjustment system 70a and the valve system 60a function as a flow restrictor, where operation of the first adjustment member 72a results in a variation in the size of the conduit passageway 42a within the valve system 60a such that a pressure of the fluid material upstream of the first flow adjustment system 70a is relatively higher than the pressure of the fluid material downstream of the first flow adjustment system 70a.

In general, a primary purpose of the first flow adjustment system 70a is to alter a distance of travel of the dispensed material 22a. The first flow adjustment system 70a may also have a secondary effect on the pattern in which the dispensed material 22a is sprayed.

The second adjustment system 80a is supported by the actuator structure 54a downstream of the first adjustment system 70a. Manual operation of the second adjustment member 82a affects the flow of fluid material flowing out of the conduit passageway 42a through the conduit outlet 46a. In particular, the second adjustment system 80a functions as a variable orifice, where operation of the second adjustment member 82a variably reduces the size of the conduit outlet 46a relative to the size of the conduit passageway 42a upstream of the second adjustment system 80a.

A primary purpose of the second flow adjustment system 80a is to alter a pattern in which the dispensed material 22a is sprayed. The first flow adjustment system 70a may also have a secondary effect on the distance of travel of the dispensed material 22a.

To operate the first example aerosol dispensing system 20, the container 30a is grasped such that the finger can depress the actuator structure 54a. The conduit outlet or outlet opening 46a is initially aimed at a test surface and the actuator structure 54a is depressed to place the valve system 60a in the open configuration such that the pressurized material 36a forces some of the stored material 34a out of the container 30a and onto the test surface to form a test texture pattern. The test texture pattern is compared to the pre-existing texture pattern defined by the textured portion 26a of the target surface 24a. If the test texture pattern does not match the pre-existing texture pattern, one or both of the first and second adjustment systems 70a and 80a are adjusted to alter the spray pattern of the droplets of dispensed material 22a.

The process of spraying a test pattern and comparing it to the pre-existing pattern and adjusting the first and second adjustment members 72a and 82a is repeated until the dispensed material forms a desired texture pattern that substantially matches the pre-existing texture pattern.

Leaving the first and second adjustment systems 70a and 80a as they were when the test texture pattern matched the pre-existing texture pattern, the aerosol dispensing system 20a is then arranged such that the conduit outlet or outlet opening 46a is aimed at the un-textured portion 28a of the target surface 24a. The actuator structure 54a is again depressed to operate the valve system 60a such that the pressurized material 36a forces the stored material 34a out of the container 30a and onto the un-textured portion 28a of the target surface to form the desired texture pattern.

### B. Second Example Aerosol Assembly

Referring now to FIG. 2 of the drawing, depicted at 20b therein is a fifth example aerosol dispensing system constructed in accordance with, and embodying, the principles of the present invention. The fifth example dispensing system is adapted to spray droplets of dispensed material 22b onto a target surface 24b. The example target surface 24b has a textured portion 26b and an un-textured portion 28b. Accordingly, in the example use of the dispensing system 20b depicted in FIG. 2, the dispensed material 22b is or contains texture material, and the dispensing system 20b is being used to form a coating on the un-textured portion 28b having a desired texture pattern that substantially matches a pre-existing texture pattern of the textured portion 26b.

The example dispensing system 20b comprises a container 30b defining a chamber 32b in which stored material 34b and pressurized material 36b are contained. The stored material 34b is a mixture of texture material, propellant material in liquid phase, and propellant material in liquid phase.

FIG. 2 further illustrates that the first example aerosol dispensing system 20b comprises a conduit 40b defining a conduit passageway 42b. The conduit 40b is supported by the container 30b such that the conduit passageway 42b defines a conduit inlet 44b arranged within the chamber 32b and a conduit outlet 46b arranged outside of the chamber 32b. The conduit outlet 46b may alternatively be referred to herein as an outlet opening 46b. The example conduit 40b is formed by an inlet tube 50b, a valve housing 52b, and an actuator structure 54b. The conduit passageway 42b extends through the inlet tube 50b, the valve housing 52b, and the actuator structure 54b such that the valve housing 52b is arranged between the conduit inlet 44b and the actuator structure 54b and the actuator structure 54b is arranged between the valve housing 52b and the conduit outlet 46b.

Arranged within the valve housing 52b is a valve system 60b. A first flow adjustment system 70b having a first adjustment member 72b is arranged to interface with the valve system 60b. A second flow adjustment system 80b having a second adjustment member 82b is arranged in the conduit passageway 42b to form at least a portion of the conduit outlet 46b.

The valve system 60b operates in a closed configuration, a fully open configuration, and at least one of a continuum or plurality of partially open intermediate configurations. In the closed configuration, the valve system 60b substantially prevents flow of fluid along the conduit passageway 42b. In the open configuration and the at least one intermediate configuration, the valve system 60b allows flow of fluid along the conduit passageway 42b. The valve system 60b is normally in the closed configuration. The valve system 60b engages the actuator member structure 54b and is placed into the open configuration by applying deliberate manual force on the actuator structure 54b towards the container 30b.

The first flow adjustment system 70b is supported by the container 30b to engage the actuator structure such that manual operation of the first adjustment member 72b controls the flow of fluid material along the conduit passageway 42b. In particular, the first adjustment system 70b functions as a flow restrictor, where operation of the first adjustment member 72b results in a variation in the size of a portion of the conduit passageway 42b such that a pressure of the fluid material upstream of the first flow adjustment system 70b is relatively higher than the pressure of the fluid material downstream of the first flow adjustment system 70b.

In general, a primary purpose of the first flow adjustment system 70b is to alter a distance of travel of the dispensed material 22b. The first flow adjustment system 70b may also have a secondary effect on the pattern in which the dispensed material 22b is sprayed.

The second adjustment system 80b is supported by the actuator structure 54b downstream of the first adjustment system 70b. Manual operation of the second adjustment member 82b affects the flow of fluid material flowing out of the conduit passageway 42b through the conduit outlet 46b. In particular, the second adjustment system 80b functions as a variable orifice, where operation of the second adjustment member 72b variably reduces the size of the conduit outlet 46b relative to the size of the conduit passageway 42b upstream of the second adjustment system 80b.

A primary purpose of the second flow adjustment system 80b is to alter a pattern in which the dispensed material 22b is sprayed. The first flow adjustment system 70b may also have a secondary effect on the distance of travel of the dispensed material 22b.

To operate the fifth example aerosol dispensing system 20b (of the second example class of dispensing systems), the container 30b is grasped such that the finger can depress the actuator structure 54b. The conduit outlet or outlet opening 46b is initially aimed at a test surface and the actuator structure 54b is depressed to place the valve system 60b in the open configuration such that the pressurized material 36b forces some of the stored material 34b out of the container 30b and onto the test surface to form a test texture pattern. The test texture pattern is compared to the pre-existing texture pattern defined by the textured portion 26b of the target surface 24b. If the test texture pattern does not match the pre-existing texture pattern, one or both of the first and second adjustment systems 70b and 80b are adjusted to alter the spray pattern of the droplets of dispensed material 22b.

The process of spraying a test pattern and comparing it to the pre-existing pattern and adjusting the first and second adjustment members 72b and 82b is repeated until the dispensed material forms a desired texture pattern that substantially matches the pre-existing texture pattern.

Leaving the first and second adjustment systems 70b and 80b as they were when the test texture pattern matched the pre-existing texture pattern, the aerosol dispensing system 20b is then arranged such that the conduit outlet or outlet opening 46b is aimed at the un-textured portion 28b of the target surface 24b. The actuator structure 54b is again depressed to operate the valve system 60b such that the pressurized material 36b forces the stored material 34b out of the container 30b and onto the un-textured portion 28b of the target surface to form the desired texture pattern.

### IV. Stored Material Examples

As generally described above, a texture material concentrate is combined with a propellant to form stored material that is arranged within an aerosol assembly. In this section, several examples of such stored material formulations will be described.

The following Table IV-1 contains a first example stored material in which the concentrate portion is formed by the first example generic formulation described above in Table IA-1. In this Table IV-1, the generic material is listed in column 1, the function of each generic material is listed in column 2, and first and second ranges of the generic materials as a percentage of the total stored material are listed in columns 3 and 4.

TABLE IV-1

| | | First | Second |
|---|---|---|---|
| Material | Function | Range | Range |
| Concentrate portion | Texture Base | 85-93% | 80-95% |
| Water | Foaming agent | 0.1-3.0% | 0.1-5% |
| Hydrocarbon propellant | Propellant Material | 7-13% | 1-20% |

The propellant material is any hydrocarbon propellant material compatible with the remaining components of the stored material. The hydrocarbon propellant in Table IV-1 is typically one or more liquidized gases either organic (such as dimethyl ether, alkanes that contain carbons less than 6, either straight chain or branched structure, or any organic compounds that are gaseous in normal temperature), or inorganic (such as carbon dioxide, nitrogen gas, or compressed air). The propellants used in current formulations are dimethyl ether (DME) and A-70.

The following Table IV-2 contains a second example stored material in which the concentrate portion is formed by the second example generic formulation described above in Table IA-2. In this Table IV-2, the generic material is listed in column 1, the function of each generic material is listed in column 2, and first and second ranges of the generic materials as a percentage of the total stored material are listed in columns 3 and 4.

TABLE IV-2

| | | First | Second |
|---|---|---|---|
| Material | Function | Range | Range |
| Concentrate portion | Texture Base | 85-93% | 80-95% |
| Water | Foaming agent | 0.1-3.0% | 0.1-5% |
| Hydrocarbon propellant | Propellant Material | 7-13% | 1-20% |

The propellant material is any hydrocarbon propellant material compatible with the remaining components of the stored material. The hydrocarbon propellant in Table IV-2 is typically one or more liquidized gases either organic (such as dimethyl ether, alkanes that contain carbons less than 6, either straight chain or branched structure, or any organic compounds that are gaseous in normal temperature), or inorganic (such as carbon dioxide, nitrogen gas, or compressed air). The propellants used in current formulations are dimethyl ether (DME) and A-70.

The following Table IV-3 contains a third example stored material in which the concentrate portion is formed by the first example specific formulation of Tables A of Exhibit A. In this Table IV-3, the generic material is listed in column 1, the function of each generic material is listed in column 2, and an example and first and second ranges of the generic materials as a percentage of the total stored material are listed in columns 3, 4, and 5, respectively.

TABLE IV-3

| | | | First | Second |
|---|---|---|---|---|
| Material | Function | Example | Range | Range |
| Concentrate | Texture Base | | 85-93% | 80-95% |
| portion | | | | |
| Water | Foaming agent | | 0.1-3.0% | 0.1-5% |
| Hydrocarbon | Propellant | | 7-13% | 1-20% |
| propellant | Material | | | |

The propellant material is any hydrocarbon propellant material compatible with the remaining components of the stored material. The hydrocarbon propellant in Table IV-3 is typically one or more liquidized gases either organic (such as dimethyl ether, alkanes that contain carbons less than 6, either straight chain or branched structure, or any organic compounds that are gaseous in normal temperature), or inorganic (such as carbon dioxide, nitrogen gas, or compressed air). The propellants used in current formulations are dimethyl ether (DME) and A-70.

The following Table IV-4 contains a fourth example stored material in which the concentrate portion is formed by the first example specific formulation of Table B of Exhibit B. In this Table IV-4, the generic material is listed in column 1, the function of each generic material is listed in column 2, and an example and first and second ranges of the generic materials as a percentage of the total stored material are listed in columns 3, 4, and 5, respectively.

TABLE IV-4

| | | | First | Second |
|---|---|---|---|---|
| Material | Function | Example | Range | Range |
| Concentrate | Texture Base | | 85-93% | 80-95% |
| portion | | | | |
| Water | Foaming agent | | 0.1-3.0% | 0.1-5% |
| Hydrocarbon | Propellant | | 7-13% | 1-20% |
| propellant | Material | | | |

The propellant material is any hydrocarbon propellant material compatible with the remaining components of the stored material. The hydrocarbon propellant in Table IV-4 is typically one or more liquidized gases either organic (such as dimethyl ether, alkanes that contain carbons less than 6, either straight chain or branched structure, or any organic compounds that are gaseous in normal temperature), or inorganic (such as carbon dioxide, nitrogen gas, or compressed air). The propellants used in current formulations are dimethyl ether (DME) and A-70.

### EXHIBIT A

TABLE A-1

| | | Commercial | | | | Second |
|---|---|---|---|---|---|---|
| Ref. | Material | Example | Function/Description | Example | First Range | Range |
| A | Diacetone | | Medium-evaporating, | 3.85 | 3.85 ± 5% | 3.85 ± 10% |
| | alcohol | | low odor solvent | | | |
| B | Propylene | | Slow evaporating, low | 2.31 | 2.31 ± 5% | 2.31 ± 10% |
| | Carbonate | | odor solvent | | | |
| C | Denatured | PM 6193-200 | Fast evaporating, low | 13.33 | 13.33 ± 5% | 13.33 ± 10% |
| | Ethanol | | odor solvent | | | |
| D | Resin | TB-044 resin (Dai) | Acrylic resin/binder | 4.93 | 4.93 ± 5% | 4.93 ± 10% |
| | | | (soluble in “weak” | | | |
| | | | solvents) | | | |
| E | Clay | Bentone 34 | Anti-settle/anti-sag clay | 1.26 | 1.26 ± 5% | 1.26 ± 10% |
| | Pigment | | pigment | | | |
| F | Fumed | Aerosil R972 | Anti-settle fumed silica | 0.08 | 0.08 ± 5% | 0.08 ± 10% |
| | Silica | | | | | |
| G | Dispersant | Byk Anti-Terra 204 | Dispersing aid | 0.51 | 0.51 ± 5% | 0.51 ± 10% |
| H | Calcium | MarbleWhite 200 | filler/extender | 33.87 | 33.87 ± 5% | 33.87 ± 10% |
| | carbonate | (Specialty Minerals) | | | | |
| I | Nepheline | Minex 4 | filler/extender | 33.87 | 33.87 ± 5% | 33.87 ± 10% |
| | syenite | | | | | |
| J | Denatured | PM 6193-200 | Fast evaporating, low | 4.00 | 4.00 ± 5% | 4.00 ± 10% |
| | Ethanol | | odor solvent | | | |
| K | Denatured | PM 6193-200 | Fast evaporating, low | 1.99 | 1.99 ± 5% | 1.99 ± 10% |
| | Ethanol | | odor solvent | | | |
| | | | | 100 | | |

### EXHIBIT A

TABLE A-2

| | | Commercial | | | | |
|---|---|---|---|---|---|---|
| Ref. | Material | Example | Function/Description | Example | First Range | Second Range |
| A | Diacetone | | Medium-evaporating, low | 13.73 | 5-15% | 0-20% |
| | alcohol | | odor solvent | | | |
| B | Propylene | | Slow evaporating, low odor | 2.11 | 1-3% | 0-5% |
| | Carbonate | | solvent | | | |
| C | Denatured | PM 6193-200 | Fast evaporating, low odor | 10.56 | 5-15% | 0-20% |
| | Ethanol | | solvent | | | |
| D | Resin | TB-044 resin | Acrylic resin/binder | 4.93 | 2-6% | 1-10% |
| | | (Dai) | (soluble in “weak” solvents) | | | |
| E | Clay | Bentone 34 | Anti-settle/anti-sag clay | 1.26 | 0.5-1.5% | 0.1-2.0% |
| | Pigment | | pigment | | | |
| F | Fumed | Aerosil R972 | Anti-settle fumed silica | 0.08 | 0-0.20% | 0-0.50% |
| | Silica | | | | | |
| G | Dispersant | Byk Anti-Terra | Dispersing aid | 0.51 | 0.3-0.7% | 0.1-1.5% |
| | | 204 | | | | |
| H | Calcium | MarbleWhite | filler/extender | 33.87 | 20-40% | 0-70% |
| | carbonate | 200 (Specialty | | | | |
| | | Minerals) | | | | |
| I | Nepheline | Minex 4 | filler/extender | 33.87 | 20-40% | 0-70% |
| | syenite | | | | | |
| J | Titanium | | White pigment | 0.00 | 0-5% | 0-20% |
| | Dioxide | | | | | |
| K | Calcined | Optiwhite | White extender pigment | 0.00 | 0-10% | 0-20% |
| | clay | | | | | |
| L | Hexane | | Very fast evaporating, low | 0.00 | 0-10% | 0-20% |
| | | | odor solvent | | | |

### EXHIBIT B

TABLE B

| | | Commercial | | | | Second |
|---|---|---|---|---|---|---|
| Ref. | Material | Example | Function/Description | Example | First Range | Range |
| A | Diacetone | | Medium-evaporating, | 6.53 | 6.53 ± 5% | 6.53 ± 10% |
| | alcohol | | low odor solvent | | | |
| B | Propylene | | Slow evaporating, low | 2.31 | 2.31 ± 5% | 2.31 ± 10% |
| | Carbonate | | odor solvent | | | |
| C | Denatured | PM 6193-200 | Fast evaporating, low | 9.03 | 9.03 ± 5% | 9.03 ± 10% |
| | Ethanol | | odor solvent | | | |
| D | Resin | TB-044 resin (Dai) | Acrylic resin/binder | 4.73 | 4.73 ± 5% | 4.73 ± 10% |
| | | | (soluble in “weak” | | | |
| | | | solvents) | | | |
| E | Clay | Bentone SD-2 | Anti-settle/anti-sag clay | 1.26 | 1.26 ± 5% | 1.26 ± 10% |
| | Pigment | | pigment | | | |
| F | Fumed | Aerosil R972 | Anti-settle fumed silica | 0.08 | 0.08 ± 5% | 0.08 ± 10% |
| | Silica | | | | | |
| G | Dispersant | Byk Lactimon | Dispersing aid | 1.95 | 1.95 ± 5% | 1.95 ± 10% |
| H | Calcium | MarbleWhite 200 | filler/extender | 32.54 | 32.54 ± 5% | 32.54 ± 10% |
| | carbonate | (Specialty Minerals) | | | | |
| I | Nepheline | Minex 4 | filler/extender | 32.54 | 32.54 ± 5% | 32.54 ± 10% |
| | syenite | | | | | |
| J | Denatured | PM 6193-200 | Fast evaporating, low | 7.05 | 7.05 ± 5% | 7.05 ± 10% |
| | Ethanol | | odor solvent | | | |
| K | Diacetone | | Medium-evaporating, | 1.98 | 1.98 ± 5% | 1.98 ± 10% |
| | alcohol | | low odor solvent | | | |
| | | | | 100 | | |

What is claimed is:

1. A texture material composition comprising:
solvent comprising between 11.0% and 72.0% by weight of the texture material;
binder comprising between 3.0% and 8.0% by weight of the texture material;
pigment comprising between 0.5% and 3.0% by weight of the texture material;
an anti-settling agent comprising between 0.01% and 0.20% by weight of the texture material;
a dispersant comprising between 0.20% and 3.0% by weight of the texture material; and
filler comprising between 50.0% and 80.0% by weight of the texture material.

2. A texture material composition as recited in claim 1, in which:
the solvent comprises between 17.5% and 39.0% by weight of the texture material;
the binder comprises between 4.0% and 6.0% by weight of the texture material;
the pigment comprises between 1.0% and 2.0% by weight of the texture material;
the anti-settling agent comprises between 0.05% and 0.10% by weight of the texture material;
the dispersant comprises between 0.25% and 2.25% by weight of the texture material; and
the filler comprises between 60.0% and 70.0% by weight of the texture material.

3. A texture material composition as recited in claim 1, in which the solvent is at least one of Diacetone alcohol, Propylene Carbonate, and Denatured Ethanol.

4. A texture material composition as recited in claim 1, in which the resin is an acrylic resin.

5. A texture material composition as recited in claim 1, in which the pigment is a clay pigment.

6. A texture material composition as recited in claim 1, in which the anti-settling agent is fumed silica.

7. A texture material composition as recited in claim 1, in which the filler is at least one of Calcium carbonate and Nepheline syenite.

8. A texture material composition as recited in claim 1, in which:
the solvent is at least one of Diacetone alcohol, Propylene Carbonate, and Denatured Ethanol;
the resin is an acrylic resin;
the pigment is a clay pigment;
the anti-settling agent is fumed silica; and
the filer is at least one of Calcium carbonate and Nepheline syenite.

9. A texture material composition comprising:
a medium evaporating solvent comprising between 1.0% and 20.0% by weight of the texture material;
a slow evaporating solvent comprising between 0.0% and 10.0% by weight of the texture material;
a fast evaporating solvent comprising between 8.0% and 57.0% by weight of the texture material;
binder comprising between 3.0% and 10.0% by weight of the texture material;
pigment comprising between 0.5% and 3.0% by weight of the texture material;
an anti-settling agent comprising between 0.01% and 0.25% by weight of the texture material;
a dispersant comprising between 0.20% and 3.0% by weight of the texture material; and
filler comprising between 50.0% and 80.0% by weight of the texture material.

10. A texture material composition as recited in claim 9, in which:
the medium evaporating solvent comprising between 3.0% and 8.0% by weight of the texture material;
the slow evaporating solvent comprising between 2.0% and 3.0% by weight of the texture material;
a fast evaporating solvent comprising between 12.5% and 28.0% by weight of the texture material;
binder comprising between 4.0% and 6.0% by weight of the texture material;
pigment comprising between 1.0% and 2.0% by weight of the texture material;
an anti-settling agent comprising between 0.05% and 0.10% by weight of the texture material;
a dispersant comprising between 0.25% and 2.25% by weight of the texture material; and
filler comprising between 60.0% and 70.0% by weight of the texture material.

11. A texture material composition as recited in claim 9, in which the medium evaporating solvent evaporates at a slower rate than the fast evaporating solvent and at a higher rate than the slow evaporating solvent.

12. A texture material composition as recited in claim 9, in which the medium evaporating solvent is Diacetone alcohol.

13. A texture material composition as recited in claim 9, in which the slow evaporating solvent is Propylene Carbonate.

14. A texture material composition as recited in claim 9, in which the fast evaporating solvent is Denatured Ethanol.

15. A texture material composition as recited in claim 9, in which the resin is an acrylic resin.

16. A texture material composition as recited in claim 9, in which the pigment is a clay pigment.

17. A texture material composition as recited in claim 9, in which the anti-settling agent is fumed silica.

18. A texture material composition as recited in claim 9, in which the filler is at least one of Calcium carbonate and Nepheline syenite.

19. A texture material composition as recited in claim 9, in which:
the medium evaporating solvent is Diacetone alcohol;
the slow evaporating solvent is Propylene Carbonate;
the fast evaporating solvent is Denatured Ethanol;
the disperant is solution of a partial amide and alkylammonium salt of a lower molecular weight unsaturated polycarboxylic acid polymer and a polisiloxane copolymer;
the resin is an acrylic resin;
the pigment is a clay pigment;
the anti-settling agent is fumed silica; and
the filer is at least one of Calcium carbonate and Nepheline syenite.
